(19) United States
(12) Patent Application Publication
(10) Pub. No.: US 2025/0222929 A1
(43) Pub. Date: Jul. 10, 2025

(54) METHOD OF CONTROLLING OPERATION OF A VEHICLE, COMPUTER PROGRAM, COMPUTER-READABLE MEDIUM, CONTROL ARRANGEMENT, AND VEHICLE

(71) Applicant: Scania CV AB, Södertälje (SE)

(72) Inventors: Manne Held, Falun (SE); Mikael Alenius, Segeltorp (SE); Oscar Flärdh, Älvsjö (SE)

(73) Assignee: Scania CV AB, Södertälje (SE)

(21) Appl. No.: 18/999,989

(22) Filed: Dec. 23, 2024

(30) Foreign Application Priority Data
Jan. 10, 2024 (SE) 2450016-7

(51) Int. Cl. B60W 30/14; B60W 10/04; B60W 10/18

(52) U.S. Cl. CPC B60W 30/146; B60W 10/04; B60W 10/18; B60W 2300/125; B60W 2540/10

(57) ABSTRACT

A method of controlling operation of a vehicle is disclosed, wherein the method is performed by a control arrangement, and wherein the vehicle comprises a propulsion system, wheel brakes, and an accelerator pedal. The method comprises, when an actuation state of the accelerator pedal is below a threshold state, controlling a braking power provided by at least one of the propulsion system and the wheel brakes based on map data representative of a road section on which the vehicle is/will be travelling. The present disclosure further relates to a computer program, a computer-readable medium, a control arrangement, and a vehicle.

### TECHNICAL FIELD

The present disclosure relates to a method of controlling operation of a vehicle. The present disclosure further relates to a computer program, a computer-readable medium, a control arrangement, and a vehicle comprising a propulsion system and a control arrangement.

### BACKGROUND

Propulsion systems are used in vehicles to provide motive power to the vehicle. Traditionally, these systems have been primarily powered by internal combustion engines, which convert chemical energy from fuel into mechanical energy. However, with advancements in technology and growing environmental concerns, alternative forms of propulsion have gained prominence. These include hybrid systems, which combine the traditional internal combustion engine with electric power, and fully electric systems, which rely solely on electric motors supplied with electricity from batteries, from fuel cells, and/or from an external source such as a pantograph.

Each type of propulsion system offers distinct advantages and challenges. Internal combustion engine systems are known for their high power output and long-range capabilities, but they also contribute to environmental pollution and have relatively low energy efficiency as compared to most electric systems. Hybrid systems attempt to balance the benefits of combustion engines and electric motors, offering improved fuel efficiency and reduced emissions. Fully electric vehicles can eliminate direct emissions and can offer high energy efficiency, but face challenges such as limited range and longer refuelling times compared to vehicles operating on conventional fuels.

Controlling the operation of a vehicle for optimal energy efficiency poses significant challenges, particularly in dynamic driving situation. In dynamic driving situations, variables such as frequent stop-and-go movements, varying speed limits, unpredicted actions of other drivers, and varying road inclination and curvature require continuous adjustments in vehicle operation. These factors can lead to inconsistent engine or motor performance, increased fuel consumption or battery drain, and higher emissions in combustion and hybrid systems. Additionally, the need to constantly adapt to changing traffic patterns can prevent the propulsion system from operating at its most efficient state which is often achieved at steady speeds or under specific load conditions.

Regenerative braking systems of vehicles are designed to recapture energy during vehicle deceleration. Regenerative braking system exist in various forms across different vehicles. In at least partially electric vehicles, such as fully electric and hybrid electric vehicles, one common approach is to store at least a portion of the electricity generated by the electric motor during braking in an electric energy storage system of the vehicle. The electric energy storage system may comprise a number of batteries and/or a number of supercapacitors. The stored energy can subsequently be used to propel the vehicle, and/or to power other systems of the vehicle, thus enhancing the overall energy efficiency of the vehicle. Another type of auxiliary braking system employs flywheel energy storage, which harnesses the braking energy to spin a flywheel, which can then release this energy to assist in propelling the vehicle during acceleration. Moreover, hydraulic regenerative systems, especially prevalent in some larger vehicles like buses, store energy by pressurizing hydraulic fluid, which can later be used to aid in propulsion of the vehicle.

The primary purpose of regenerative braking systems is to reduce the overall energy consumption of the vehicle and extend the range of vehicles. By recovering energy that would otherwise be wasted, regenerative braking systems play a crucial role in improving the total energy efficiency of these vehicles.

However, in certain driving situations, especially in emergency scenarios or under heavy braking, the use of traditional wheel brakes is necessary. While regenerative systems are highly effective in normal conditions, they are not always sufficient to provide the required stopping power in all situations. The reliance on wheel brakes in these instances leads to a direct loss of kinetic energy as heat, which reduces the total energy efficiency of the vehicle. This is particularly evident in stop-and-go traffic conditions and urban driving, where frequent braking is common.

Moreover, a frequent use of wheel brakes not only leads to a loss of kinetic energy but also results in increased wear and tear of the brake components. This wear and tear necessitate more frequent maintenance and replacement of brake parts, which adds to the overall operating costs and environmental impact due to the manufacturing and disposal of these components.

A so called one-pedal-drive mode is a driving feature designed to simplify and enhance the driving experience of a vehicle. When activated, this mode allows a driver to control both acceleration and deceleration using a single pedal, namely the accelerator pedal. As under normal circumstances, pressing the accelerator pedal increases the vehicle's speed.

However, in one-pedal-drive mode, the release of the accelerator pedal triggers a retardation force to slow down the vehicle. This braking action may be achieved through a combination of regenerative braking and traditional friction braking systems.

Accordingly, when the one-pedal-drive mode is activated and the driver eases off the accelerator, the vehicle begins to decelerate more rapidly than it would in a conventional coasting scenario. This feature thus reduces the need to switch frequently between the accelerator and brake pedals, thereby offering a simpler and smoother driving experience for the driver.

In some variations of this mode, drivers may have the option to select the level of retardation force applied upon releasing the accelerator. In such variants, the feature may allow for a range of deceleration intensities, from a gentle reduction in speed to a more significant braking force that can bring the vehicle to a complete halt, potentially eliminating the need to use a brake pedal under certain conditions.

Furthermore, a one-pedal-drive mode may utilize a regenerative braking system of the vehicle for decelerating the vehicle. In this manner, the kinetic energy of the vehicle can be captured and transformed into a form of energy suitable for storage, such as electrical energy. This stored energy may be subsequently used for various purposes, such as powering the vehicle's electrical systems and/or providing additional propulsion. This process not only provides efficient braking but also helps in conserving energy and extending the vehicle's range.

In summary, the one-pedal-drive mode offers a more intuitive and energy-efficient way of driving. It simplifies the driving process, reduces driver fatigue, and contributes to energy conservation through the integration of regenerative braking technology.

However, despite the advantages of a one-pedal-drive mode pointed out above, several challenges exist concerning the driving experience, energy-efficiency, vehicle dynamics, and safety of operation of the vehicle. Regarding the driving experience, adapting to the one-pedal system can initially be unintuitive for drivers accustomed to conventional two-pedal driving, potentially leading to errors or discomfort. Moreover, most vehicles equipped with a one-pedal-drive mode require the driver to use the brake pedal in many driving situations to achieve the desired retardation of the vehicle. Conversely, in some driving situations, the retardation may be higher than desired when the driver releases the accelerator pedal. This not only impairs the driving experience but also can make it difficult to operate the vehicle in an energy-efficient manner. Furthermore, this may cause abrupt or jerky movements that could destabilize the vehicle, thereby potentially compromising the vehicle dynamics, and safety of operation of the vehicle.

### SUMMARY

It is an object of the present invention to overcome, or at least alleviate, at least some of the above-mentioned problems and drawbacks. The object is achieved by the subject-matter of the appended independent claim(s).

According to a first aspect of the present disclosure, the object is achieved by a method of controlling operation of a vehicle, wherein the method is performed by a control arrangement, and wherein the vehicle comprises a propulsion system, wheel brakes, and an accelerator pedal, wherein the method comprises the step of, when an actuation state of the accelerator pedal is below a threshold state:
controlling a braking power provided by at least one of the propulsion system and the wheel brakes based on map data representative of a road section on which the vehicle is/will be travelling.

Since the method comprises the step of controlling the braking power based on the map data representative of a road section on which the vehicle is/will be travelling, a method is provided having conditions for improving the driving experience for a driver of the vehicle, as well as the energy-efficiency, the vehicle dynamics, and the safety of operation of the vehicle.

The driving experience for a driver of the vehicle can be improved because the control of the braking power based on the map data can ensure that a braking power is applied in an adaptive manner to better align with a current driving situation, and potentially also align with a conscious or subconscious intent of the driver, without requiring an actual input of such an intent of from the driver.

Moreover, due to the control of the braking power based on the map data, conditions are provided for allowing the driver of the vehicle to operate the vehicle longer distances and in a wider range of situations without having to use a brake pedal of the vehicle. Furthermore, the vehicle can be operated in a more planned, controlled, and adaptive manner. In this manner, abrupt or jerky movements of the vehicle can be avoided which potentially can improve the energy-efficiency, the vehicle dynamics, and the safety of operation of the vehicle.

Accordingly, a method is provided overcoming, or at least alleviating, at least some of the above-mentioned problems and drawbacks. As a result, the above-mentioned object is achieved.

Optionally, the method comprises the step of:
performing the step of controlling the braking power provided by at least one of the propulsion system and the wheel brakes in response to a detection of a reduction event of the actuation state of the accelerator pedal.

The reduction event may encompass an event in which the driver fully releases the accelerator pedal or partially releases the accelerator pedal. By controlling the braking power based on the map data in response to a detection of a reduction event of the actuation state of the accelerator pedal, it can be ensured that a braking power is applied in an adaptive manner to better align with a current driving situation, and potentially also align with a conscious or subconscious intent of the driver, without requiring an actual input of such an intent of from the driver.

Optionally, the method comprises the step of:
estimating a braking need of the vehicle based on the map data, and
   wherein the step of controlling the braking power comprises:
controlling the braking power based on the estimated braking need.

Thereby, conditions are provided for further improving the driving experience for a driver of the vehicle, as well as the energy-efficiency, the vehicle dynamics, and the safety of operation of the vehicle. This is because by controlling the braking power based on the estimated braking need, the braking power can be controlled in an even further controlled and adaptive manner. Moreover, this can enable a driver to operate the vehicle over longer distances and in a broader range of situations without having to use a brake pedal of the vehicle.

Optionally, the step of controlling the braking power comprises:
controlling both the propulsion system and the wheel brakes to brake the vehicle if the braking need exceeds a threshold, and
controlling the propulsion system to solely brake the vehicle if the current braking need is below the threshold.

Thereby, conditions are provided for further improving the safety of operation of the vehicle. In addition, conditions are provided for operating the vehicle in a more energy-efficient manner, while minimizing wear and tear of the wheel brakes of the vehicle. This is because the step of controlling the propulsion system to solely brake the vehicle if the current braking need is below the threshold provides conditions for capturing the kinetic energy of the vehicle in a regenerative braking system of the propulsion system and transforming it into useful energy. Likewise, the step of controlling the propulsion system to solely brake the vehicle if the current braking need is below the threshold circumvents the need for using the wheel brakes in situations in which the current braking need is below the threshold, thereby minimizing wear and tear of the wheel brakes.

Optionally, the method comprises:
setting the threshold based on a current available braking capacity of the propulsion system.

Thereby, conditions are provided for operating the vehicle in a more energy-efficient manner, while minimizing wear and tear of the wheel brakes of the vehicle. This is because it can be ensured that braking power is provided by the wheel brakes only in situations in which the estimated braking need exceeds the current available braking capacity of the propulsion system.

Optionally, the propulsion system comprises a regenerative braking system, and wherein the method comprises the step of:
setting the threshold based on a current available braking capacity of the regenerative braking system of the propulsion system.

Thereby, conditions are provided for operating the vehicle in an even more energy-efficient manner, while minimizing wear and tear of the wheel brakes of the vehicle. This is because it can be ensured that the level of regenerative braking of the vehicle is maximized before the wheel brakes of the vehicle are utilized to slow down the vehicle.

Optionally, the method comprises the step of:
determining, based on the map data, a distance between the vehicle and a portion of the road section comprising a geometrical, regulatory, and/or navigational alteration, and
   wherein the step of controlling the braking power comprises the step of:
controlling the braking power based on the determined distance.

Thereby, a method is provided capable of even further improving the driving experience for a driver of the vehicle, as well as the energy-efficiency, the vehicle dynamics, and the safety of operation of the vehicle.

The driving experience for a driver of the vehicle can be even further improved because the control of the braking power based on the determined distance to a geometrical, regulatory, and/or navigational alteration of a road section on which the vehicle is/will be travelling can ensure that a braking power is applied in an adaptive to more accurately align with a conscious or subconscious intent of the driver without requiring an actual input of such an intent from the driver.

Moreover by controlling the braking power based on the determined distance between the vehicle and a portion of the road section comprising a geometrical, regulatory, and/or navigational alteration, conditions are provided for enabling the driver of the vehicle to operate the vehicle even longer distances and in broader ranges of situations without having to use a brake pedal of the vehicle. Furthermore, the vehicle can be operated in an even more planned, controlled, and adaptive manner. Accordingly, in this manner, abrupt or jerky movements of the vehicle can be further avoided which potentially can improve the energy-efficiency, the vehicle dynamics, and the safety of operation of the vehicle.

In other words, by controlling the braking power based on the determined distance to the alteration, it can be ensured that the vehicle is braked in a smooth, controlled, safe, and energy-efficient manner before the vehicle is reaching the alteration. As a further result thereof, wear and tear of the wheel brakes of the vehicle can be further minimized.

Optionally, the portion of the road section comprises a geometrical alteration in the form of at least one of a change in curvature of the road, a change in inclination of the road, a change in width of the road, and a change in type of road surface, and/or wherein the portion of the road section comprises a regulatory alteration in the form of at least one of a speed limit change, a stop duty, a traffic signal location, a yield point, and a change in lane usage rules, and/or wherein the portion of the road section comprises a navigational alteration in the form of at least one of a road exit, an intersection, a crossing, and a roundabout.

Optionally, the method comprises the steps of:
determining, based on the map data, a target speed to be reached at a portion the road section, and
controlling the braking power for reaching the target speed at the portion the road section.

Thereby, a method is provided capable of even further improving the driving experience for a driver of the vehicle, as well as the energy-efficiency, the vehicle dynamics, and the safety of operation of the vehicle.

The driving experience for a driver of the vehicle can be even further improved because by controlling the braking power for reaching the target speed at the portion the road section, it can be ensured that a braking power is applied in an adaptive manner to align with a conscious or subconscious intent of the driver more accurately without requiring an actual input of such an intent from the driver.

Moreover by controlling the braking power for reaching the target speed at the portion the road section, conditions are provided for enabling the driver of the vehicle to operate the vehicle even longer distances and in broader ranges of situations without having to use a brake pedal of the vehicle. Furthermore, the vehicle can be operated in a more planned, controlled, and adaptive manner. Accordingly, in this manner, abrupt or jerky movements of the vehicle can be further avoided which potentially can improve the energy-efficiency, the vehicle dynamics, and the safety of operation of the vehicle.

In other words, by controlling the braking power for reaching the target speed at the portion the road section, it can be ensured that the vehicle is braked in a smooth, controlled, safe, and energy-efficient manner before the vehicle is reaching the alteration. As a further result thereof, wear and tear of the wheel brakes of the vehicle can be further minimized.

Optionally, the propulsion system comprises a regenerative braking system controllable to regeneratively brake the vehicle, and wherein the method comprises the steps of:
estimating a braking energy need for reaching the target speed at the portion the road, and
setting a distribution between braking power provided by the propulsion system and braking power provided by the wheel brakes based on the estimated braking energy need and a current available braking capacity of the regenerative braking system.

Thereby, a method is provided capable of further improving the energy-efficiency of the vehicle, while ensuring the safety of operation of the vehicle.

According to a second aspect of the present disclosure, the object is achieved by a computer program comprising instructions to cause the control arrangement according to the second aspect of the present disclosure to execute the steps of the method according to some embodiments of the first aspect of the present disclosure. Since the computer program comprises instructions to cause the control arrangement to carry out the method according to some embodiments described herein, a computer program is provided which provides conditions for overcoming, or at least alleviating, at least some of the above-mentioned drawbacks. As a result, the above-mentioned object is achieved.

According to a third aspect of the present disclosure, the object is achieved by a computer-readable medium having stored thereon the computer program according to the second aspect of the present disclosure. Since the computer-readable medium comprises instructions to cause the control arrangement to carry out the method according to some embodiments described herein, a computer-readable medium is provided which provides conditions for overcoming, or at least alleviating, at least some of the above-mentioned drawbacks. As a result, the above-mentioned object is achieved.

According to a fourth aspect of the present disclosure, the object is achieved by a control arrangement configured to control operation of a vehicle, wherein the vehicle comprises a propulsion system, wheel brakes, and an accelerator pedal, wherein the control arrangement is configured to, when an actuation state of the accelerator pedal is below a threshold state:
control a braking power provided by at least one of the propulsion system and the wheel brakes based on map data representative of a road section on which the vehicle is/will be travelling.

Since the control arrangement is configured to control the braking power based on the map data representative of a road section on which the vehicle is/will be travelling, a control arrangement is provided having conditions for improving the driving experience for a driver of the vehicle, as well as the energy-efficiency, the vehicle dynamics, and the safety of operation of the vehicle.

The driving experience for a driver of the vehicle can be improved because the control of the braking power based on the map data can ensure that a braking power is applied in an adaptive manner to better align with a current driving situation, and potentially also align with a conscious or subconscious intent of the driver, without requiring an actual input of such an intent of from the driver.

Moreover, due to the control of the braking power based on the map data, conditions are provided for enabling the driver of the vehicle to operate the vehicle longer distances and in a broader range of situations without having to use a brake pedal of the vehicle. Furthermore, the vehicle can be operated in a more planned, controlled, and adaptive manner. Thereby, abrupt or jerky movements of the vehicle can be avoided which potentially can improve the energy-efficiency, the vehicle dynamics, and the safety of operation of the vehicle.

Accordingly, a control arrangement is provided overcoming, or at least alleviating, at least some of the above-mentioned problems and drawbacks. As a result, the above-mentioned object is achieved.

It will be appreciated that the various embodiments described for the method are all combinable with the control arrangement as described herein. That is, the control arrangement according to the fourth aspect of the invention may be configured to perform any one of the method steps of the method according to the first aspect of the invention.

According to a fifth aspect of the present disclosure, the object is achieved by a vehicle comprising a propulsion system, wheel brakes, an accelerator pedal, and a control arrangement according to some embodiments of the present disclosure. Since the vehicle comprises a control arrangement according to some embodiments, a vehicle is provided overcoming, or at least alleviating, at least some of the above-mentioned problems and drawbacks. As a result, the above-mentioned object is achieved.

Optionally, the vehicle is a heavy road vehicle, such as a truck or a bus. Thereby, a heavy road vehicle is provided having at least some of the above-mentioned advantages.

Further features of, and advantages with, the present invention will become apparent when studying the appended claims and the following detailed description.

### BRIEF DESCRIPTION OF THE DRAWINGS

Various aspects of the present disclosure, including its particular features and advantages, will be readily understood from the example embodiments discussed in the following detailed description and the accompanying drawings, in which:

FIG. 1 schematically illustrates a top-view of a vehicle according to some embodiments as positioned on a first example of a road section,

FIG. 2 schematically illustrates a first side-view of the vehicle illustrated in FIG. 1 as positioned on a second example of a road section,

FIG. 3 schematically illustrates a second side-view of the vehicle illustrated in FIG. 1 and FIG. 2 as positioned on a third example of a road section,

FIG. 4 schematically illustrates a method of controlling operation of a vehicle, and

FIG. 5 illustrates a computer-readable medium.

### DETAILED DESCRIPTION

Aspects of the present disclosure will now be described more fully. Like reference signs refer to like elements throughout. Well-known functions or constructions will not necessarily be described in detail for brevity and/or clarity.

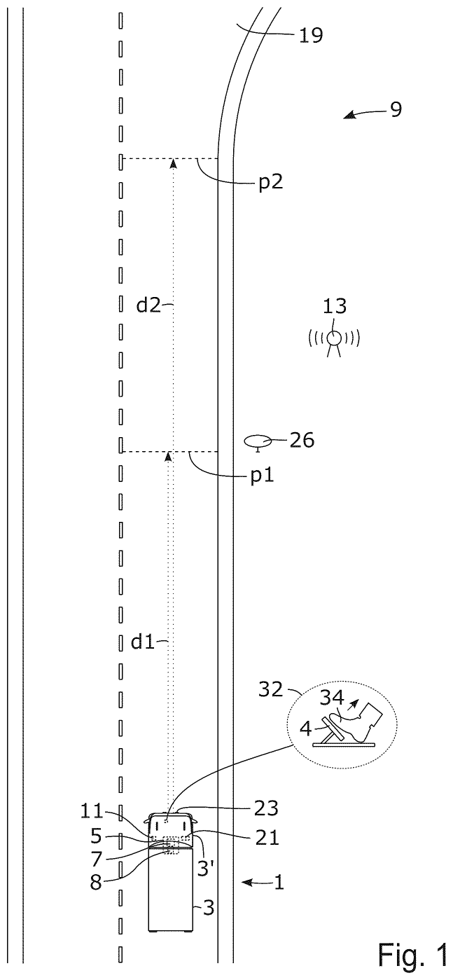

FIG. 1 schematically illustrates a top-view of a vehicle 1 according to some embodiments as positioned on a first example of a road section 9. According to the illustrated embodiments, the vehicle 1 is a truck, i.e., a type of heavy road vehicle as well as a type of heavy commercial vehicle. According to further embodiments, the vehicle 1, as referred to herein, may be another type of heavy or lighter type of vehicle for land-based propulsion such as a lorry, a bus, a construction vehicle, a tractor, a car, or the like.

As indicated in FIG. 1, the vehicle 1 comprises wheel brakes 3, 3′ controllable to brake the vehicle 1. The wheel brakes 3, 3′ are controllable to brake the vehicle 1 by braking rotation of wheels of the vehicle 1. The wheels of the vehicle 1 are not indicated in FIG. 1 for reasons of brevity and clarity. The wheel brakes 3, 3′ may comprise friction brake arrangements, such as drum brakes, disc brakes, or a combination thereof. Drum brakes normally comprise a cylinder-shaped part called a brake drum and a set of shoes or pads controllable to be pressed against the cylinder-shaped part to create friction therebetween for braking rotation of the wheels. Disc brakes normally comprise a disc and a set of pads controllable to be pressed against the disc to create friction therebetween for braking rotation of the wheels.

Moreover, as indicated in FIG. 1, the vehicle 1 comprises a propulsion system 5. The propulsion system 5 is configured to provide motive power to the vehicle 1 via wheels of the vehicle 1. Moreover, the propulsion system 5 is configured to provide a braking power to the vehicle 1 via wheels of the vehicle 1. According to the illustrated embodiments, the propulsion system 5 comprises a power source in the form of an internal combustion engine 7. The internal combustion engine 7 may be a diesel engine, i.e. a type of compression ignition engine. The internal combustion engine 7 may thus be configured to operate on diesel or a diesel-like fuel, such as biodiesel, biomass to liquid (BTL), or gas to liquid (GTL) diesel. Diesel-like fuels, such as biodiesel, can be obtained from renewable sources such as vegetable oil which mainly comprises fatty acid methyl esters (FAME). Diesel-like fuels can be produced from many types of oils, such as rapeseed oil (rapeseed methyl ester, RME) and soybean oil (soy methyl ester, SME).

According to further embodiments, the internal combustion engine 7, as referred to herein, may another type of Otto engine with a spark-ignition device, wherein the Otto engine may be configured to run on petrol, alcohol, or combinations thereof. Alcohol, such as ethanol, can be derived from renewable biomass. According to embodiments herein, the internal combustion engine 7 is a four-stroke internal combustion engine 7.

Moreover, the internal combustion engine 7 may be an Otto engine with a spark-ignition device, wherein the Otto engine is configured to run on a gaseous fuel. The gaseous fuel may also be referred to as fuel gas and may encompass any type of fuel that under ordinary ambient temperature and pressure conditions are gaseous and which can be stored at pressure in a pressure tank and can be combusted in an internal combustion engine 7 to produce useful work. Examples of such gaseous fuels are compressed natural gas (CNG), liquified natural gas (LNG), Liquefied Petroleum Gas (LPG), Hydrogen (H2), Biogas, and Syngas. Many gaseous fuels can be derived from renewable sources, such as from renewable biomass.

Moreover, according to the illustrated embodiments, the propulsion system 5 of the vehicle 1 comprises a regenerative braking system 8. The regenerative braking system 8 is controllable to regeneratively brake the vehicle 1 via wheels of the vehicle 1. In more detail, according to the illustrated embodiments, the regenerative braking system 8 comprises an electric machine controllable to regeneratively brake the vehicle 1, wherein the energy derived from braking the vehicle 1 can be stored in an electric energy storage system of the vehicle 1.

The electric energy storage system may comprise one or more propulsion battery packs each comprising a number of rechargeable battery cells, such as lithium-ion battery cells, lithium polymer batteries cells, nickel-metal hydride battery cells, or the like. The battery cells may be arranged in battery modules, wherein each of the one or more propulsion battery packs may comprise a number of battery modules. The stored energy can subsequently be used to provide motive power to the vehicle 1 utilizing the above mentioned electric machine. In other words, according to the illustrated embodiments, the vehicle 1 is a so called hybrid electric vehicle comprising the combination of an internal combustion engine 7 and an electric machine for providing motive power to the vehicle 1.

However, according to further embodiments, the vehicle 1, as referred to herein, may be fully electric vehicle comprising a pure electric propulsion system, i.e., a propulsion system comprising a number of electric machines and no internal combustion engine for providing motive power to the vehicle 1 via wheels of the vehicle 1. In such embodiments, the regenerative braking system 8 of the propulsion system 5 may comprise one or more of the number of electric machines.

Furthermore, according to some embodiments, the vehicle 1 may comprise an internal combustion engine 7 as the only means for providing motive power to the vehicle 1 and no electrical propulsion machine.

Moreover, the vehicle 1 may comprise another type of regenerative braking system 8 than explained above, such as a hydraulic or pneumatic regenerative auxiliary braking system. Such an auxiliary braking system may comprise a hydraulic or pneumatic pump/motor controllable to brake the vehicle 1 and to convert the braking energy into potential energy within a pressure tank by pumping a fluid into the pressure tank upon braking. In such embodiments, the pressurized fluid may be usable for subsequently providing motive power to the vehicle 1, for example using the pump/motor of the hydraulic or pneumatic regenerative auxiliary braking system. Moreover, according to some embodiments, the regenerative braking system 8 of the vehicle 1 may comprise a flywheel configured to store energy derived from braking in the form of rotation of the flywheel.

As indicated in FIG. 1, the vehicle 1 further comprises a control arrangement 21 and an accelerator pedal 4. In the schematic representation of the vehicle 1 of FIG. 1, the accelerator pedal 4 is illustrated inside a dashed ellipse 32. However, as indicated with the line connecting the dashed ellipse 32 to the vehicle 1, the accelerator pedal 4 is arranged inside a driver environment of the vehicle 1. Moreover, as indicated in FIG. 1, the accelerator pedal 4 is configured to be actuated, i.e., pressed, by a foot 34 of a driver of the vehicle 1. The control arrangement 21 is configured to control a power output of the propulsion system 5 based on an actuation state of the accelerator pedal 4.

According to the illustrated embodiments, the control arrangement 21 is configured to determine the actuation state of the accelerator pedal 4 by inputting data from a sensor arranged to sense the actuation state of the accelerator pedal 4. Such a sensor may be arranged to sense the actuation state of the accelerator pedal 4 by monitoring a position of the accelerator pedal 4.

Moreover, according to embodiments herein, the control arrangement 21 of the vehicle 1 is configured to control operation of the vehicle 1, including operation of the wheel brakes 3, 3′ and the propulsion system 5 of the vehicle 1. In more detail, the control arrangement 21 is configured to control a braking power provided by at least one of the propulsion system 5 and the wheel brakes 3, 3′ based on the map data representative of a road section 9 on which the vehicle 1 is/will be travelling when the actuation state of the accelerator pedal 4 is below a threshold state.

In this manner, the control arrangement 21 can improve the driving experience for a driver of the vehicle, as well as the energy-efficiency, the vehicle dynamics, and the safety of operation of the vehicle 1, as is further explained herein.

The threshold state, as referred to herein, may be set to a value equal or below a state in which the vehicle 1 transitions from acceleration in a forward moving direction of the vehicle 1 to a deceleration. In other words, the threshold state may be set to correspond to a state in which no vehicle acceleration is obtained in the forward and reverse moving directions of the vehicle 1 given a current driving situation. According to further embodiments, the threshold state may be set to a fixed value, such as a value normally causing retardation of the vehicle 1. The control arrangement 21 may be configured to determine if the actuation state of the accelerator pedal 4 is below the threshold state by comparing the actuation state and the threshold state.

According to some embodiments, the control arrangement 21 may be configured to control the braking power provided by at least one of the propulsion system 5 and the wheel brakes 3, 3′ based on the map data in response to a detection of a reduction event of the actuation state of the accelerator pedal 4.

The reduction event may encompass an event in which the driver fully releases the accelerator pedal 4 or partially releases the accelerator pedal 4. The control arrangement 21 may be configured to detect the reduction event by inputting data from the above mentioned type of sensor configured to sense the actuation state of the accelerator pedal 4.

The reduction event of the actuation state of the accelerator pedal 4, as referred to herein, means an event in which the actuation state of the accelerator pedal 4 decreases. In this context, it could correspond to any instance where the actuation of the accelerator pedal 4 lessens, typically when the driver eases off or removes their foot 34 from the accelerator pedal 4.

The control arrangement 21 may be configured to obtain the map data representative of a road section 9 on which the vehicle 1 is/will be travelling from an onboard system or from an external sender 13, such as a sender of a communication unit for mobile devices.

Moreover, the vehicle 1 may comprise a vehicle positioning device configured to provide a current position estimate of the vehicle 1. Such a vehicle positioning device may for example utilize a space-based satellite navigation system such as a Global Positioning System (GPS), The Russian GLObal NAvigation Satellite System (GLONASS), European Union Galileo positioning system, Chinese Compass navigation system, or Indian Regional Navigational Satellite System. The control arrangement 21 may be configured to control the braking power provided by at least one of the propulsion system 5 and the wheel brakes 3, 3′ based on the map data and the current position estimate of the vehicle 1.

According to the illustrated embodiments, the vehicle 1 comprises a sensor assembly 23 configured to monitor a driving environment in front of the vehicle 1. The sensor assembly 23 is operably connected to the control arrangement 21. The sensor assembly 23 may comprise one or more of an image capturing device, such as a camera, a LiDAR (Light Detection and Ranging) sensor, a radar (Radio Detection and Ranging) sensor, and an ultrasonic sensor.

An image capturing device works by capturing visual data in the form of images or videos. This allows the control arrangement 21 to identify and interpret various aspects of the driving environment in front of the vehicle 1. LiDAR sensors function by emitting pulsed laser light and measuring the time it takes for the light to bounce back after hitting an object. This data can be used to create accurate, three-dimensional information about the surrounding environment, including a precise distance and shape of objects. Radar sensors use radio waves to detect objects and determine their speed and distance. They emit radio waves that reflect off objects and return to the sensor, allowing the system to calculate the object's position and velocity, even in poor visibility conditions. Lastly, ultrasonic sensors work by emitting ultrasonic sound waves. These waves reflect off objects and return to the sensor, which then calculates the distance to the object based on the time it takes for the sound waves to return.

According to some embodiments, the control arrangement 21 is configured to estimate a braking need of the vehicle 1 based on the map data and control the braking power provided by at least one of the propulsion system 5 and the wheel brakes 3, 3′ based on the estimated braking need. Obviously, the control arrangement 21 may be configured to control the braking power based on the estimated braking need such that the braking power is increased with increasing braking needs and is reduced with reducing braking needs. As is further detailed below, according to the illustrated embodiments, the control arrangement 21 may be configured to supplement, and/or adjust, the estimated braking need of the vehicle 1 based on data from the sensor assembly 23.

The control arrangement 21 may be configured to estimate the braking need of the vehicle 1 by comparing a current position estimate of the vehicle 1 and the map data. Moreover, the control arrangement 21 may be configured to estimate the braking need of the vehicle 1 by identifying portions p1, p2 of the road section 9 comprising a geometrical, regulatory, and/or navigational alteration from the map data.

Furthermore, the control arrangement 21 may be configured to determine, based on the map data and a current position estimate of the vehicle 1, a distance d1, d2 between the vehicle 1 and a portion p1, p2 of the road section 9 comprising a geometrical, regulatory, and/or navigational alteration, wherein the control arrangement 21 is configured to control the braking power based on the determined distance d1, d2.

In the schematic example of FIG. 1, a portion p1 of the road section 9 comprises a regulatory alteration in the form of a speed limit change. The speed limit change is indicated by a traffic sign 26 and a dashed line in FIG. 1. The control arrangement 21 may thus determine a distance d1 between the vehicle 1 and the portion p1 of the road section 9 and may thus control the braking power based on the determined distance d1. In this example, the control arrangement 21 may also be configured to identify the allowed speed after the speed limit change, and/or may also be configured to identify if the speed limit change constitutes an increase or decrease in allowed speed as compared to a portion of the road section at which the vehicle 1 is currently located. The control arrangement 21 may also be configured to adapt the control of the braking power based on such identification/identifications.

In the above example of the speed limit change at the portion p1 of the road section 9, the control arrangement 21 may be configured to verify the presence and/or location of the speed limit change using data from an image capturing device of the sensor assembly 23. Moreover, in this example, the control arrangement 21 may be configured to identify the allowed speed after the speed limit change, and/or identify if the speed limit change constitutes an increase or decrease in allowed speed as compared to a portion of the road section at which the vehicle 1 is currently located, by using data from an image capturing device of the sensor assembly 23. Moreover, the control arrangement 21 may be configured to adapt the estimated braking need and accordingly also the control of the braking power according to such verifications and identifications.

As indicated above, the control arrangement 21 may be configured to control the braking power based on a characteristic of a geometrical, regulatory, and/or navigational alteration of the road section 9 on which the vehicle 1 is/will be travelling. The characteristic of the geometrical, regulatory, and/or navigational alteration may be obtained from the map data and/or from data inputted from the sensor assembly 23. In the above example of the regulatory alteration in the form of the speed limit change, the characteristic thereof may comprise the allowed speed after the speed limit change, and/or if the speed limit change constitutes an increase or decrease in allowed speed as compared to a portion of the road section at which the vehicle 1 is currently located.

Moreover, the control arrangement 21 may be configured to control the braking power provided by at least one of the propulsion system 5 and the wheel brakes 3, 3′ based on a current speed of the vehicle 1. In other words, according to some embodiments, the control arrangement 21 may be configured to, when the actuation state of the accelerator pedal 4 is below the threshold state, control the braking power provided by at least one of the propulsion system 5 and the wheel brakes 3, 3′ based on a current speed of the vehicle 1, a distance d1 to a portion p1 of the road section 9 comprising a geometrical, regulatory, and/or navigational alteration, and a characteristic of said alteration.

In the above example, the control arrangement 21 may be configured to control the braking power such that the braking power is increased with reducing distances d1 to the speed limit change if the speed limit change constitutes a reduction in vehicle speed as compared to the current speed of the vehicle 1. If the speed limit change constitutes an increase in vehicle speed as compared to the current speed of the vehicle 1, the control arrangement 21 may be configured to control the braking power provided by at least one of the propulsion system 5 and the wheel brakes 3, 3′ to a reduced level in response to a detection of a reduction event of the actuation state of the accelerator pedal 4.

Furthermore, according to some embodiments, the control arrangement 21 may be configured to determine, based on the map data, a target speed to be reached at a portion p1, p2 the road section 9, wherein the control arrangement 21 is configured to control the braking power for reaching the target speed at the portion p1, p2 the road section 9. The control arrangement 21 may be configured to set the target speed based on a characteristic of the geometrical, regulatory, and/or navigational alteration. In the above example of the regulatory alteration in the form of a speed limit change, the target speed may be set to correspond to an allowed speed after the speed limit change.

The above example of the regulatory alteration in the form of a speed limit change should only be seen as an example of a regulatory alteration which the control arrangement 21 according to embodiments herein possibly could identify from the map data and adapt the braking power in response to. However, the control arrangement 21 may, as an alternative, or in addition, be configured to identify other types of regulatory alterations from the map data, such as one or more of a stop duty, a traffic signal location, a yield point, and a change in lane usage rules. In the example of a stop duty, the control arrangement 21 may be configured to set the target speed to be reached at the stop duty to a zero vehicle speed, i.e., a stand-still of the vehicle 1.

Furthermore, the control arrangement 21 may be configured to identify a geometrical alteration in the form of at least one of a change in curvature of the road, a change in inclination of the road, a change in width of the road, and a change in type of road surface. As a further alternative, or in addition, the control arrangement 21 may be configured to identify a navigational alteration in the form of at least one of a road exit 19, an intersection, a crossing, and a roundabout.

In the schematic example of FIG. 1, a portion p2 of the road section 9 comprises a navigational alteration in the form of a road exit 19. As indicated above, the control arrangement 21 may be configured to determine a distance d2 between the vehicle 1 and the portion p2 comprising the road exit 19 and may be configured to control the braking power provided by at least one of the propulsion system 5 and the wheel brakes 3, 3′ based on the determined distance d2. Moreover, the control arrangement 21 may be configured to control the braking power based on a characteristic of the road exit 19. The characteristic of the road exit may for example involve an allowed or appropriate speed at the road exit 19. Moreover, in this example, the control arrangement 21 may be configured to control the braking power based on information from a navigation system of the vehicle 1 indicating whether the driver has an intent to depart from the road via the road exit 19 or not.

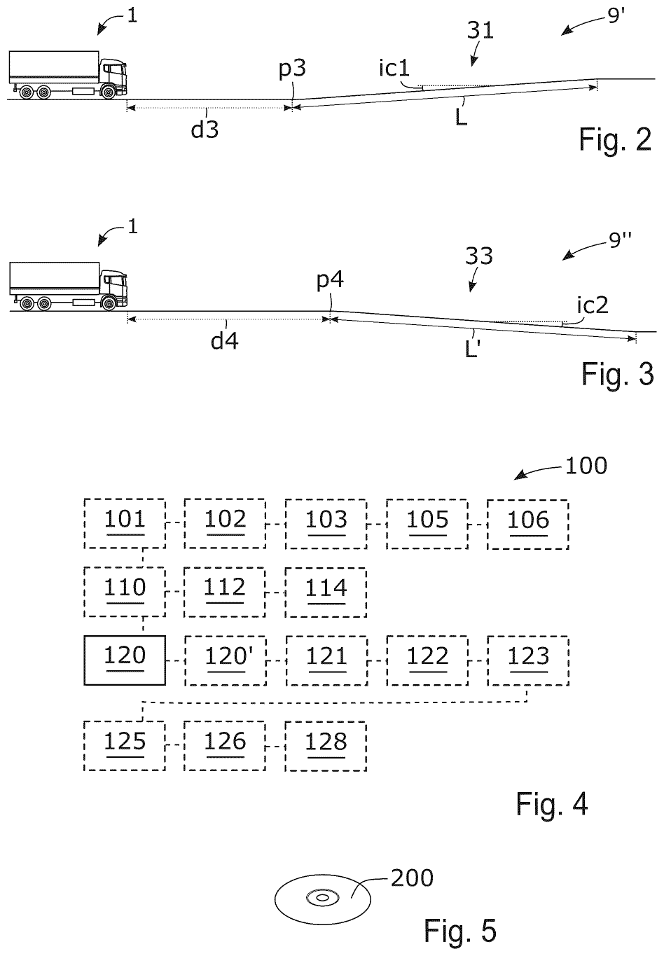

FIG. 2 schematically illustrates a first side-view of the vehicle 1 illustrated in FIG. 1 as positioned on a second example of a road section 9′. The second example of the road section 9′ comprises a portion p3 with a geometrical alteration in the form of a change in inclination ic1 of the road. That is, in FIG. 2, the vehicle 1 is illustrated as positioned onto a flat ground surface and is illustrated as approaching an uphill slope 31. In other words, in the example of FIG. 2, the geometrical alteration is in the form of an increase in gradient of the road. As is further detailed below, the control arrangement 21 may be configured to determine a distance d3 between the vehicle 1 and the portion p3 of the road section 9′ using the map data and a current position estimate of the vehicle 1, and may be configured to control the braking power based on the determined distance d3.

FIG. 3 schematically illustrates a second side-view of the vehicle 1 illustrated in FIG. 1 and FIG. 2 as positioned on a third example of a road section 9″. The third example of the road section 9″ comprises a portion p4 with a geometrical alteration in the form of a change in inclination ic2 of the road. More specifically, in FIG. 3, the vehicle 1 is illustrated as positioned onto a flat ground surface and is illustrated as approaching a downhill slope 33. In other words, in the example of FIG. 3, the geometrical alteration is in the form of a decrease in gradient of the road. As is further detailed below, the control arrangement 21 may be configured to determine a distance d4 between the vehicle 1 and the portion p4 of the road section 9″ using the map data and a current position estimate of the vehicle 1, and may be configured to control the braking power based on the determined distance d4.

Below, simultaneous reference is made to FIG. 1-FIG. 3, if not indicated otherwise. As explained above with reference to FIG. 1, the control arrangement 21 may be configured to control the braking power based on a characteristic of a geometrical, regulatory, and/or navigational alteration of the portion p1-p4 of the road section 9, 9′, 9″. Moreover, as indicated with reference to FIG. 1, the control arrangement 21 may be configured to set a target speed to be reached at a portion p1-p4 of a road section 9, 9′, 9″ on which the vehicle 1 is/will be travelling based on a characteristic of an alteration.

In the examples of FIG. 2 and FIG. 3, the characteristic of the geometrical alteration may be represented by at least one of the direction of change of the gradient/inclination ic1, ic2 of the road, the magnitude of the change of the gradient/inclination ic1, ic2, and the magnitude of the gradient/inclination ic1, ic2 of the road. Moreover, in these embodiments, the control arrangement 21 may be configured to determine the target speed to be reached at a portion p3, p4 of a road based on a length L, L′ of an uphill or downhill slope 31, 33.

If the geometrical alteration involves a decrease in gradient of the road, such as for example a beginning of a downhill slope 33 as depicted in FIG. 3, the control arrangement 21 may increase the braking power and reduce the target speed, as compared to if the geometrical alteration involves an increase in gradient of the road, such as for example a beginning of an uphill slope 31 as depicted in FIG. 2.

Accordingly, in the examples of FIG. 2 and FIG. 3, the control arrangement 21 may be configured to set the target speed to be reached at the portion p4 in FIG. 3 to a lower value than the target speed to be reached at the portion p3 in FIG. 2, given that other circumstances are equal in these examples. In this manner, a more-energy efficient operation of the vehicle 1 can be ensured when the actuation state of the accelerator pedal 4 is below the threshold state. This is because, in the situation depicted in FIG. 2, the relatively higher target speed at the portion p3 can provide an efficiency gain by avoiding high-load conditions on the propulsion system 5 while ascending the uphill slope 31, which are typically less efficient. That is, by providing a relatively higher target speed in anticipation of the uphill slope 31, the vehicle 1 can tackle the incline more efficiently, using the gained momentum to reduce the strain on the propulsion system 5. Furthermore, in the situation depicted in FIG. 3, the relatively lower target speed at the portion p4 can provide an efficiency gain by a harness of the gravitational assistance during the descent of the downhill slope 33.

In other words, by proactively setting the target speed based on a characteristic of, and a distance d1-d4 to, a geometrical, regulatory, and/or navigational alteration, the vehicle 1 can be operated in a more energy-efficient manner. Moreover, the driving experience for a driver of the vehicle 1, as well as the vehicle dynamics, and the safety of operation of the vehicle 1 can be improved.

According to some embodiments, the control arrangement 21 is configured to control both the propulsion system 5 and the wheel brakes 3, 3′ to brake the vehicle 1 if the braking need exceeds a threshold and to control the propulsion system 5 to solely brake the vehicle 1 if the current braking need is below the threshold. The threshold may also be referred to as a threshold need.

Moreover, the control arrangement 21 may be configured to set the threshold based on a current available braking capacity of the propulsion system 5. As mentioned above, according to the illustrated embodiments, the propulsion system 5 comprises a regenerative braking system 8 controllable to regeneratively brake the vehicle 1. In these embodiments, the control arrangement 21 may be configured to set the threshold based on a current available braking capacity of the regenerative braking system 8 of the propulsion system 5. Furthermore, the control arrangement 21 may be configured to adapt or set the threshold based on one or more other factors, such as weather conditions, a current road friction estimate, and the like.

Moreover, the control arrangement 21 may be configured to estimate a braking energy need for reaching a target speed at a portion p1-p4 the road comprising a geometrical, regulatory, and/or navigational alteration, and set a distribution between braking power provided by the propulsion system 5 and braking power provided by the wheel brakes 3, 3′ based on the estimated braking energy need and a current available braking capacity of the regenerative braking system 8. In this manner, conditions are provided for operating the vehicle 1 in an even more energy-efficient manner.

According to some embodiments, the control arrangement 21 is configured to supplement the control of the braking power provided by at least one of the propulsion system 5 and the wheel brakes 3, 3′ based on a determined distance to a preceding vehicle, and possibly also a determined rate och change of the distance to a preceding vehicle. Thereby, the braking power can be controlled in a further adaptive manner, when the actuation state of the accelerator pedal 4 is below the threshold state, for example in response to a detection of a reduction event of an actuation state of the accelerator pedal 4, to further improve the driving experience for a driver of the vehicle 1, as well as the energy-efficiency, the vehicle dynamics, and the safety of operation of the vehicle 1. The control arrangement 21 may be configured to determine the distance to a preceding vehicle, and possibly also the rate of change thereof, using data from the sensor assembly 23.

Moreover, the control arrangement 21 may be configured to supplement the control of the braking power provided by at least one of the propulsion system 5 and the wheel brakes 3, 3′ based on one or more further aspects or factors, such as for example a current ambient temperature, current weather conditions, a current road friction estimate, historic data representative of historic speeds of vehicles on a road section 9, 9′, 9″ on which the vehicle 1 is/will be travelling, detection of, and/or determined distance to, a pedestrian, and the like. As a result, the braking power can be controlled in a further adaptive manner, when the actuation state of the accelerator pedal 4 is below the threshold state, for example in response to a detection of a reduction event of an actuation state of the accelerator pedal 4, to further improve the driving experience for a driver of the vehicle 1, as well as the energy-efficiency, the vehicle dynamics, and the safety of operation of the vehicle 1. The one or more further aspects or factors referred to above may be obtained from the map data, an onboard system or device, such as a device of the sensor assembly 23, and/or from an external sender 13.

As indicated above, the reduction event of the actuation state of the accelerator pedal 4, as referred to herein, may encompass an event in which the accelerator pedal 4 is fully released or is partially released. According to some embodiments, the control arrangement 21 may be configured to supplement the control of the braking power provided by at least one of the propulsion system 5 and the wheel brakes 3, 3′ based on a current actuation state of the accelerator pedal 4, a magnitude of a reduction in actuation state of the accelerator pedal 4, and/or a rate of change by which the actuation state of the accelerator pedal 4 is reduced. In this manner, the braking power can be controlled in a further adaptive manner in response to a detection of a reduction event of an actuation state of the accelerator pedal 4 to further improve the driving experience for a driver of the vehicle 1, as well as the energy-efficiency, the vehicle dynamics, and the safety of operation of the vehicle 1.

As mentioned, in the schematic example of FIG. 1, a portion p2 of the road section 9 comprises a navigational alteration in the form of a road exit 19. In FIG. 1, the portion p2 of the road section 9 is illustrated at a beginning of the road exit 19. Likewise, in FIG. 2 and FIG. 3, the portions p3, p4 comprising the geometrical alterations in the form of a changes in inclination ic1, ic2 of the road are illustrated at a respective beginning of the uphill/downhill slope 31, 33. However, a portion p1-p4 of the road section 9, 9′, 9″ comprising a geometrical, regulatory, and/or navigational alteration may be set to another location than depicted in these figures. As an example, in case of a geometrical alternation in the form of a curve, the portion may be set to an apex of the curve. As another example, in case of a geometrical alternation in the form of a change in inclination of the road, the portion may be set to a portion of an uphill or downhill slope having the greatest inclination.

FIG. 4 schematically illustrates a method 100 of controlling operation of a vehicle. The vehicle may be a vehicle 1 according to the embodiments explained with reference to FIG. 1-FIG. 3. Therefore, below, simultaneous reference is made to FIG. 1-FIG. 4, if not indicated otherwise.

The method 100 is a method of controlling operation of a vehicle 1, wherein the method 100 is performed by a control arrangement 21, and wherein the vehicle 1 comprises a propulsion system 5, wheel brakes 3, 3′, and an accelerator pedal 4, wherein the method 100 comprises the step of, when an actuation state of the accelerator pedal 4 is below a threshold state:
controlling 120 a braking power provided by at least one of the propulsion system 5 and the wheel brakes 3, 3′ based on map data representative of a road section 9, 9′, 9″ on which the vehicle 1 is/will be travelling.

Optionally, the method 100 may comprise the step of:
detecting 101 a reduction event of an actuation state of the accelerator pedal 4,
   and in response thereto:
performing the step of controlling 120 the braking power provided by at least one of the propulsion system 5 and the wheel brakes 3, 3′ based on the map data.

The step of detecting 101 a reduction event of an actuation state of the accelerator pedal 4 may be performed using data from a sensor arranged to sense the actuation state of the accelerator pedal 4.

Moreover, the method 100 may comprise the step of:
obtaining 102 a current position estimate of the vehicle 1, and
   wherein the step of controlling 120 the braking power comprises the step of:
controlling 120′ the braking power provided by at least one of the propulsion system 5 and the wheel brakes 3, 3′ based on the current position estimate and map data representative of a road section 9, 9′, 9″ on which the vehicle 1 is/will be travelling.

The step of obtaining 102 the current position estimate of the vehicle 1 may be performed using data from a vehicle positioning device of the vehicle 1. Such a vehicle positioning device may for example utilize a space-based satellite navigation system.

According to some embodiments, the method 100 comprises the step of:
estimating 103 a braking need of the vehicle 1 based on the map data,
   and wherein the step of controlling 120 the braking power comprises:
controlling 121 the braking power based on the estimated braking need.

The step of controlling 121 the braking power may comprise:
controlling 122 both the propulsion system 5 and the wheel brakes 3, 3′ to brake the vehicle 1 if the braking need exceeds a threshold, and
controlling 123 the propulsion system 5 to solely brake the vehicle 1 if the current braking need is below the threshold.

According to some embodiments, the method 100 comprises the step of:
setting 105 the threshold based on a current available braking capacity of the propulsion system 5.

The propulsion system 5 may comprise a regenerative braking system 8 controllable to regeneratively brake the vehicle 1. According to such embodiments, the method 100 may comprise the step of:
setting 106 the threshold based on a current available braking capacity of the regenerative braking system 8 of the propulsion system 5.

According to some embodiments, the method 100 comprises the step of:
determining 110, based on the map data, a distance d1-d4 between the vehicle 1 and a portion p1-p4 of the road section 9, 9′, 9″ comprising a geometrical, regulatory, and/or navigational alteration, and
   wherein the step of controlling 120 the braking power comprises the step of:
controlling 125 the braking power based on the determined distance d1-d4.

The portion p1-p4 of the road section 9, 9′, 9″ may comprise a geometrical alteration in the form of at least one of a change in curvature of the road, a change in inclination ic1, ic2 of the road, a change in width of the road, and a change in type of road surface. As an alternative, or in addition, the portion p1-p4 of the road section 9, 9′, 9″ may comprise a regulatory alteration in the form of at least one of a speed limit change, a stop duty, a traffic signal location, a yield point, and a change in lane usage rules. As a further alternative, or in addition, the portion p1-p4 of the road section 9, 9′, 9″ may comprise a navigational alteration in the form of at least one of a road exit 19, an intersection, a crossing, and a roundabout.

Moreover, according to some embodiments, the method 100 comprises the steps of:
determining 112, based on the map data, a target speed to be reached at a portion p1-p4 the road section 9, 9′, 9″, and
controlling 126 the braking power for reaching the target speed at the portion p1-p4 the road section 9, 9′, 9″.

As mentioned, according to some embodiments, the propulsion system 5 comprises a regenerative braking system 8 controllable to regeneratively brake the vehicle 1. According to such embodiments, the method 100 may comprise the steps of:
estimating 114 a braking energy need for reaching the target speed at the portion p1-p4 the road, and
setting 128 a distribution between braking power provided by the propulsion system 5 and braking power provided by the wheel brakes 3, 3′ based on the estimated braking energy need and a current available braking capacity of the regenerative braking system 8.

It will be appreciated that the various embodiments described for the method 100 are all combinable with the control arrangement 21 as described herein. That is, the control arrangement 21 may be configured to perform any one of the method steps 101, 102, 103, 105, 106, 110, 112, 114, 120, 120′, 121, 122, 123, 125, 126, and 128 of the method 100.

As understood from the herein described, the method 100 and the control arrangement 21 according to embodiments herein enable a driver of a vehicle 1 to operate a vehicle 1 in a smooth, intuitive, and controlled manner without having to use a brake pedal of the vehicle 1. Therefore, the method 100 and the control arrangement 21, as referred to herein, may form part of a so called one-pedal-drive system of the vehicle 1, and/or may be configured to provide a so called one-pedal-drive mode of the vehicle 1.

When implemented in the vehicle 1, the one-pedal-drive mode may be selectable via an input unit arranged in a driver environment of the vehicle 1, such as for example an input unit in the form of a touch sensitive screen, a button, a lever, a switch, a microphone, or the like. In other words, in such embodiments, a driver may be able to activate or deactivate the one-pedal-drive mode via such an input unit. Moreover, in such embodiments, the driver may be able to select between different modes of a one-pedal-drive system of the vehicle 1, for example via an input unit according to the above. In such embodiments, the control provided by the method 100, and/or control arrangement 21 according to embodiments herein, may constitute an adaptive mode of the one-pedal-drive system, wherein one or more other selectable modes may constitute non-adaptive modes resulting in a fix or predetermined braking power when the actuation state of the accelerator pedal 4 is below a threshold state or upon a reduction event of an actuation state of the accelerator pedal 4.

The one-pedal-drive mode, as referred to herein, may also be referred to as a single-pedal-drive mode, a one-pedal operation mode, a single-pedal control mode, or a one-pedal-drive feature. Likewise, the one-pedal-drive system, as referred to herein, may also be referred to as a single-pedal-drive system, a one-pedal operation system, or a single-pedal control system.

FIG. 5 illustrates a computer-readable medium 200 comprising instructions which, when executed by a computer, cause the computer to carry out the method 100 according to some embodiments of the present disclosure. According to some embodiments, the computer-readable medium 200 comprises a computer program comprising instructions which, when the program is executed by a computer, cause the computer to carry out the method 100 according to some embodiments. The computer may be comprised in the control arrangement 21.

One skilled in the art will appreciate that the method 100 of controlling operation of a vehicle 1 may be implemented by programmed instructions. These programmed instructions are typically constituted by a computer program, which, when it is executed in the control arrangement 21, ensures that the control arrangement 21 carries out the desired control, such as the method steps 101, 102, 103, 105, 106, 110, 112, 114, 120, 120′, 121, 122, 123, 125, 126, and 128 described herein. The computer program is usually part of a computer program product which comprises a suitable digital storage medium on which the computer program is stored, such as the computer-readable medium 200 illustrated in FIG. 5. In other words, the computer program product may be a computer readable medium 200 and the computer program may be stored in the computer readable medium 200.

The control arrangement 21 may comprise a computer which may take the form of substantially any suitable type of hardware or hardware/firmware device implemented using processing circuitry such as, but not limited to, a processor, Central Processing Unit (CPU), a controller, an arithmetic logic unit (ALU), a digital signal processor, an Application Specific Integrated Circuit (ASIC), a circuit for digital signal processing (digital signal processor, DSP), a microcomputer, a field programmable gate array (FPGA), a System-on-Chip (SoC), a programmable logic unit, a microprocessor, an application-specific integrated circuit, or any other device capable of electronically performing operations in a defined manner, or other processing logic that may interpret and execute instructions. The herein utilised expression “computer” may represent a processing circuitry comprising a plurality of processing circuits, such as, e.g., any, some or all of the ones mentioned above.

The control arrangement 21 may further comprise a memory unit, wherein the computer may be connected to the memory unit, which may provide the computer with, for example, stored program code and/or stored data which the computer may need to enable it to do calculations. The computer may also be adapted to store partial or final results of calculations in the memory unit. The memory unit may comprise a physical device utilised to store data or programs, i.e., sequences of instructions, on a temporary or permanent basis.

According to some embodiments, the memory unit may comprise integrated circuits comprising silicon-based transistors. The memory unit may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

The control arrangement 21 is connected to components of the vehicle 1 for receiving and/or sending input and output signals. These input and output signals may comprise waveforms, pulses, or other attributes which the input signal receiving devices can detect as information and which can be converted to signals processable by the control arrangement 21. These signals may then be supplied to the computer. One or more output signal sending devices may be arranged to convert calculation results from the computer to output signals for conveying to other parts of the vehicle's control system and/or the component or components for which the signals are intended. Each of the connections to the respective components of the vehicle 1 for receiving and sending input and output signals may take the form of one or more from among a cable, a data bus, e.g. a CAN (controller area network) bus, a MOST (media orientated systems transport) bus or some other bus configuration, or a wireless connection.

In the embodiments illustrated, the vehicle 1 comprises a control arrangement 21 but might alternatively be implemented wholly or partly in two or more control arrangements, two or more control arrangements, or two or more control units.

Control systems in modern vehicles generally comprise a communication bus system consisting of one or more communication buses for connecting a number of electronic control units (ECUs), or controllers, to various components on board the vehicle. Such a control system may comprise a large number of control units and taking care of a specific function may be shared between two or more of them. Vehicles and engines of the type here concerned are therefore often provided with significantly more control arrangements than depicted in FIG. 1, as one skilled in the art will surely appreciate.

The computer-readable medium 200 may be provided for instance in the form of a data carrier carrying computer program code for performing at least some of the method steps 101, 102, 103, 105, 106, 110, 112, 114, 120, 120′, 121, 122, 123, 125, 126, and 128 according to some embodiments of the method 100 when being loaded into one or more computers of the control arrangement 21. The data carrier may be, e.g. a CD ROM disc, as is illustrated in FIG. 5, or a ROM (read-only memory), a PROM (programmable read-only memory), an EPROM (erasable PROM), a flash memory, an EEPROM (electrically erasable PROM), a hard disc, a memory stick, an optical storage device, a magnetic storage device or any other appropriate medium such as a disk or tape that may hold machine readable data in a non-transitory manner. Accordingly, in some embodiments, the computer-readable medium 200 may be a non-transitory computer-readable medium, such as a tangible electronic, magnetic, optical, infrared, electromagnetic, and/or semiconductor system, apparatus, and/or device. The computer-readable medium 200 may furthermore be provided as computer program code on a server and may be downloaded to the control arrangement 21 remotely, e.g., over an Internet or an intranet connection, or via other wired or wireless communication systems.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A method of controlling operation of a vehicle, wherein the method is performed by a control arrangement, and wherein the vehicle comprises a propulsion system, wheel brakes, and an accelerator pedal, wherein the method comprises, when an actuation state of the accelerator pedal is below a threshold state:
controlling a braking power provided by at least one of the propulsion system and the wheel brakes based on map data representative of a road section on which the vehicle is/will be travelling.

2. The method according to claim 1, wherein the method comprises:
estimating a braking need of the vehicle based on the map data, and
wherein controlling the braking power comprises:
controlling the braking power based on the estimated braking need.

3. The method according to claim 2, wherein controlling the braking power comprises:
controlling both the propulsion system and the wheel brakes to brake the vehicle if the braking need exceeds a threshold; and
controlling the propulsion system to solely brake the vehicle if the current braking need is below the threshold.

4. The method according to claim 3, wherein the method comprises:
setting the threshold based on a current available braking capacity of the propulsion system.

5. The method according to claim 1, wherein the method further comprises:
determining, based on the map data, a distance between the vehicle and a portion of the road section comprising a geometrical, regulatory, and/or navigational alteration, and
wherein controlling the braking power comprises:
controlling the braking power based on the determined distance.

6. The method according to claim 5, wherein the portion of the road section comprises at least one of:
a geometrical alteration in the form of at least one of a change in curvature of the road, a change in inclination of the road, a change in width of the road, or a change in type of road surface;
a regulatory alteration in the form of at least one of a speed limit change, a stop duty, a traffic signal location, a yield point, or a change in lane usage rules;
a navigational alteration in the form of at least one of a road exit, an intersection, a crossing, or a roundabout.

7. The method according to claim 1, wherein the method comprises the steps of:
determining, based on the map data, a target speed to be reached at a portion the road section; and
controlling the braking power for reaching the target speed at the portion the road section.

8. The method according to claim 7, wherein the propulsion system comprises a regenerative braking system controllable to regeneratively brake the vehicle, and wherein the method comprises the steps of:
estimating a braking energy need for reaching the target speed at the portion the road; and
setting a distribution between braking power provided by the propulsion system and braking power provided by the wheel brakes based on the estimated braking energy need and a current available braking capacity of the regenerative braking system.

9. A computer program product stored on a non-transitory computer-readable medium, said computer program product for controllinq operation of a vehicle, wherein the vehicle comprises a propulsion system, wheel brakes, and an accelerator pedal, wherein said computer program product comprising computer instructions to cause one or more computing devices to:
when an actuation state of the accelerator pedal is below a threshold state:
control a braking power provided by at least one of the propulsion system and the wheel brakes based on map data representative of a road section on which the vehicle is/will be travelling.

10. (canceled)

11. A control arrangement configured to control operation of a vehicle, wherein the vehicle comprises a propulsion system, wheel brakes, and an accelerator pedal, wherein the control arrangement is configured to, when an actuation state of the accelerator pedal is below a threshold state:
control a braking power provided by at least one of the propulsion system and the wheel brakes based on map data representative of a road section on which the vehicle is/will be travelling.

12. A vehicle comprising:
a propulsion system;
wheel brakes;
an accelerator pedal; and
a control arrangement configured to control operation of a vehicle and is configured to, when an actuation state of the accelerator pedal is below a threshold state:
control a braking power provided by at least one of the propulsion system and the wheel brakes based on map data representative of a road section on which the vehicle is/will be travelling.

13. The vehicle according to claim 12, wherein the vehicle is a heavy road vehicle.

14. The computer program product according to claim 9, wherein said computer program product further comprises computer instructions to cause one or more computing devices to:
estimate a braking need of the vehicle based on the map data, and
wherein control of the braking power comprises:
control of the braking power based on the estimated braking need.

15. The computer program product according to claim 14, wherein control of the braking power comprises:
control of both the propulsion system and the wheel brakes to brake the vehicle if the braking need exceeds a threshold; and
control of the propulsion system to solely brake the vehicle if the current braking need is below the threshold.

16. The computer program product according to claim 15, wherein said computer program product further comprises computer instructions to cause one or more computing devices to:
set the threshold based on a current available braking capacity of the propulsion system.

17. The computer program product according to claim 9, wherein said computer program product further comprises computer instructions to cause one or more computing devices to:
determine, based on the map data, a distance between the vehicle and a portion of the road section comprising a geometrical, regulatory, and/or navigational alteration, and
wherein control of the braking power comprises:
control of the braking power based on the determined distance.

18. The control arrangement according to claim 11 further configured to:
estimate a braking need of the vehicle based on the map data, and
wherein control the braking power comprises:
control of the braking power based on the estimated braking need.

19. The control arrangement according to claim 18, wherein the control of the braking power comprises:
control of both the propulsion system and the wheel brakes to brake the vehicle if the braking need exceeds a threshold; and
control of the propulsion system to solely brake the vehicle if the current braking need is below the threshold.

20. The control arrangement according to claim 19 further configured to:
set the threshold based on a current available braking capacity of the propulsion system.

21. The control arrangement according to claim 11 further configured to:
determine, based on the map data, a distance between the vehicle and a portion of the road section comprising a geometrical, regulatory, and/or navigational alteration, and
wherein control of the braking power comprises:
control of the braking power based on the determined distance.
